(19) United States
(12) Patent Application Publication
(10) Pub. No.: US 2003/0231196 A1
(43) Pub. Date: Dec. 18, 2003

(54) Implementation for determining user interest in the portions of lengthy received web documents by dynamically tracking and visually indicating the cumulative time spent by user in the portions of received web document

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: Mark E. McBurney, International Business Machines Corporation, Intl Prop Law Dept., Internal Zip 4054, 11400 Burnet Road, Austin, TX, 78758, US

(73) Assignee: International Business Machines Corporation, Armonk, NY

(21) Appl. No.: 10/171,839

(22) Filed: Jun. 13, 2002

(51) Int. Cl. G09G 5/00

(52) U.S. Cl. 345/700; 345/787

(57) ABSTRACT

An implementation for dynamically tracking received lengthy Web documents containing text, images, media and hyperlinks to other documents to determine the user interests in the various document portions with little or no effort on the part of novice computer users to carry out such tracking. The cumulative time that said user spends in each of a plurality of document portions during the navigation via scrolling of the received Web document is tracked, and the tracked cumulative time spent in each of said portions is visually indicating within the received Web document.

### TECHNICAL FIELD

The present invention relates to computer controlled display systems, and particularly to user interfaces in such systems for scrolling displayed documents so as to facilitate a user accessing information from the documents.

### BACKGROUND OF RELATED ART

For many years the data processing industries have been devoting great resources to making computer supported user interactive display technology systems and methods to provide interactive users with an interface environment that is easy to use. This has been a major task since the great expansion of computer users over the past decade has expanded computer use to less and less skilled and sophisticated users. This effort has been further driven by the rise of the Internet or World Wide Web (Web). The latter two terms are meant to be interchangeable and are used as such throughout this application. In effect, there has been a technological revolution driven by the convergence of the data processing industry with the consumer electronics industry. This advance has been even further accelerated by the extensive consumer and business involvement in the Internet over the past five years. As a result of these changes, it seems as if virtually all aspects of human endeavor in the industrialized world requires human-computer interfaces. There is a need to make computer directed activities accessible to a substantial portion of the industrial world's population, which, up to a few years ago was computer-illiterate or, at best, computer indifferent. The population will, to a large part, have to become involved with computer interfaces and computer interfaces must, thus, continue to be simplified and made more user friendly.

This problem of simplification is particularly pronounced in the Web or Internet. Hypertext Markup Language (HTML), which has been the documentation language of the Internet or Web for years, offers direct links between pages and other documentation on the Web and a variety of related data sources that were, at first, text and then images, and now include media, i.e. “hypermedia”, which involves audio, video and all types of visual files. It is now possible for the Web user to spend literally hours going through Web pages or document after document in search of subject matter of interest to the user. It is frequently the case that after the user has gone through page upon page of Web documents, he wishes to go back through the pages to items or portions that were of particular interest. Of course, conventional Web browsing does provide the user with the opportunity to bookmark Web pages of interest. However, he is generally limited to bookmarking whole documents, which is of little value where the bookmarked documents are very lengthy and only portions were of interest. Also, bookmarking requires that the user predict that the page or document will be of interest even before he has completed his browsing or searching. It is sometimes the case that the user does not know that certain content will be of interest until he has advanced in or completed his browsing. In addition, conventional bookmarking needs to be precisely and skillfully handled by the user in order for it to be a useful and effective tool in tracking content of interest to the user. It would be particularly ineffective for the above-mentioned users of low computer skills to try to anticipate areas of greatest interest in a browsing session simply by bookmarking.

### SUMMARY OF THE PRESENT INVENTION

Accordingly, the present invention provides a simplified implementation for dynamically tracking received lengthy Web documents containing text, images, media and hyperlinks to other documents to determine the user interests in the various document portions. The invention requires little or no effort on the part of novice computer users to carry out such tracking. The invention involves a receiving Web display station comprising the combination of means enabling a user to interactively navigate in a received Web document, means for tracking the cumulative time that said user spends in each of a plurality of document portions during the navigation of the received Web document, and means for visually indicating within the received Web document said tracked cumulative time spent in each of said portions. The Web document tracking system may also include hyperlinks to other document pages, and means responsive to a user selection for further linking pages into said lengthy Web document. In such a case, the means for tracking also track cumulative user time spent in portions of said linked pages.

In accordance with another aspect of the invention, there is provided means for accessing a previously tracked Web document together with means for displaying within the previously accessed tracked Web document visual indications of said previously tracked cumulative time spent in each of said portions.

The invention also may involve means for interactively displaying a stored previously tracked Web document, and means enabling a user to interactively navigate further in said displayed previously tracked Web document together with means for dynamically tracking the additional cumulative time that the user spends in each of the plurality of document portions during the further navigation in the displayed Web document, and means for dynamically visually indicating within the displayed Web document said tracked total cumulative time spent in each of said portions.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing a user interactive workstation, such as a Web receiving station for dynamically tracking and indicating a users interest in the portions of a received lengthy document;

FIG. 2 is a generalized diagrammatic view of a Web portion upon which the present invention may be implemented;

FIG. 3 is a diagrammatic view of a Web page portion displayed and scrolled at a receiving display station with user interest in the portions of the document being indicated by colors in a scroll bar;

FIG. 4 is a diagrammatic view of a Web page like that of FIG. 3 but with a different type of scroll bar indicator;

FIG. 5 is an illustrative flowchart describing the setting up of the elements needed for the program for implementing scroll bar indicators to point to the different times of users interest in portions of scrolled received Web documents; and

FIG. 6 is a flowchart of an illustrative run of the program set up in FIG. 5.

### DETAILED DESCRIPTION OF THE PREFERRED EMBODIMENT

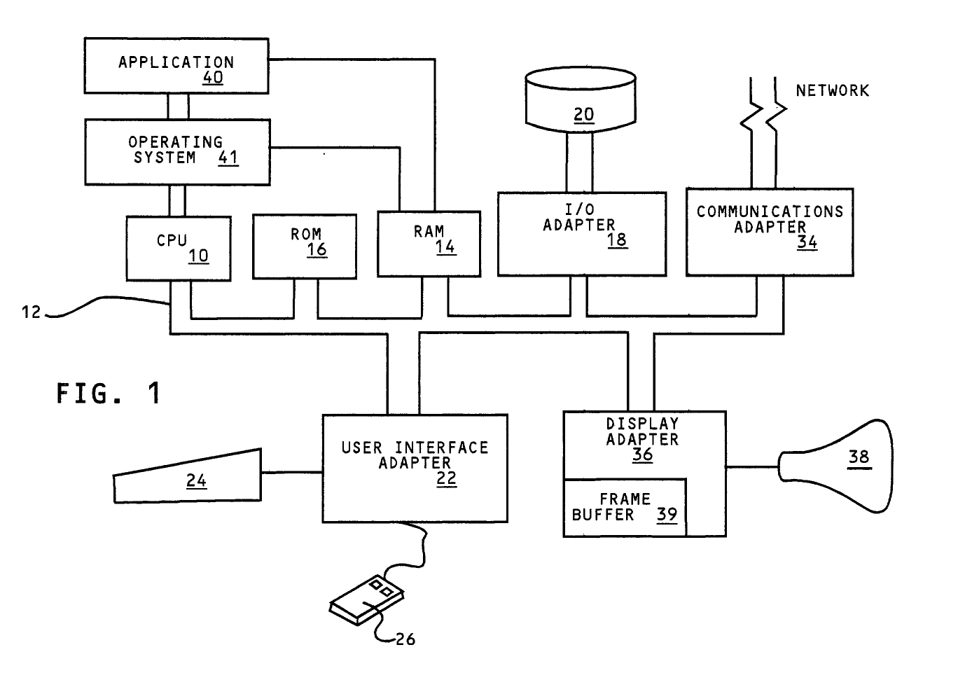

Referring to FIG. 1, a typical data processing terminal is shown that may function as a Web display station used for receiving Web pages. Such display units or Web stations may be used in the practice of the present invention for tracking cumulative time that a receiving user spends in each of a plurality of scrolled Web document portions during navigation/browsing of the documents and indicating the cumulative time spent in each portion through indicators in the scroll bar.

A central processing unit (CPU) 10 may be one of the commercial microprocessors in personal computers available from International Business Machines Corporation (IBM) or other vendors such as Dell Corp. or Sun Microsystems Inc., e.g. RISC System/6000™ (RS/6000) series available from IBM. The CPU is interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; as well as other AIX and UNIX operating systems, or Microsoft's Windows2000™ Application programs 40, controlled by the system, are moved into and out of the main memory Random Access Memory (RAM) 14. These programs include the programs of the present invention for dynamically tracking and indicating the extent of a user's interest in the portions of a received lengthy document. The programs will be subsequently described in combination with any conventional Web browser, such as the Netscape Navigator™ or Microsoft's Internet Explorer™. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other, i.e. like the Web or Internet. I/O devices are also connected to system bus 12 via user interface adapter 22 and display adapter 36. Keyboard 24 and mouse 26 are all interconnected to bus 12 through user interface adapter 22.

It is through such input devices that the user may interactively relate to Web pages. Display adapter 36 includes a frame buffer 39, which is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand, from a more general perspective, the various elements and methods that may be related to the present invention. Since the major aspect of the present invention is directed to Web pages transmitted over global networks, such as the Web or Internet, an understanding of networks and their operating principles would be helpful. We will not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999. Any data communication system that interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers.

Web documents are conventionally implemented in HTML language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference, Millennium Edition text: Chapter 19, pp. 419-454, on the Netscape Navigator; Chapter 20, pp. 455-494, on the Microsoft Internet Explorer; and Chapter 21, pp. 495-512, covering Lynx, Opera and other browsers.

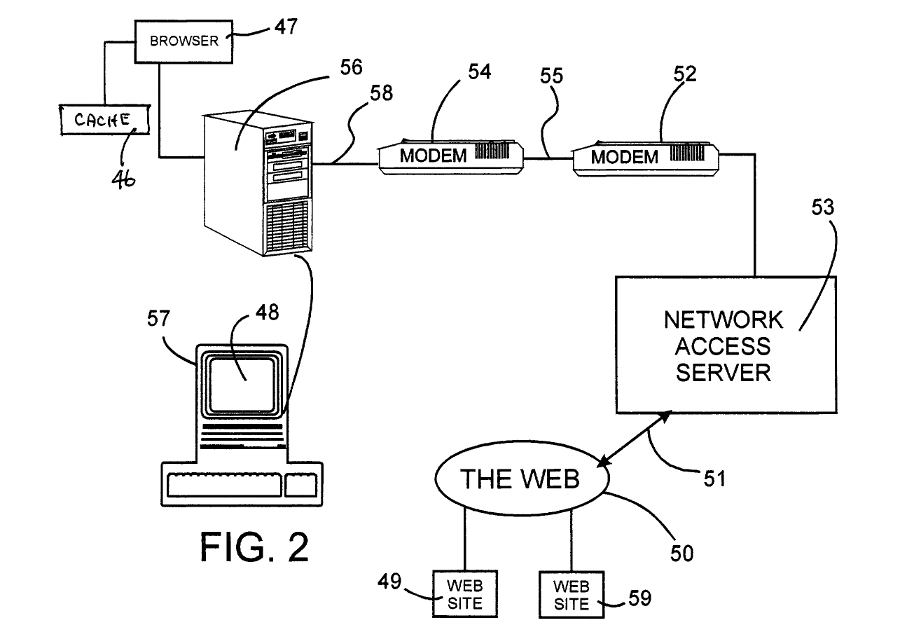

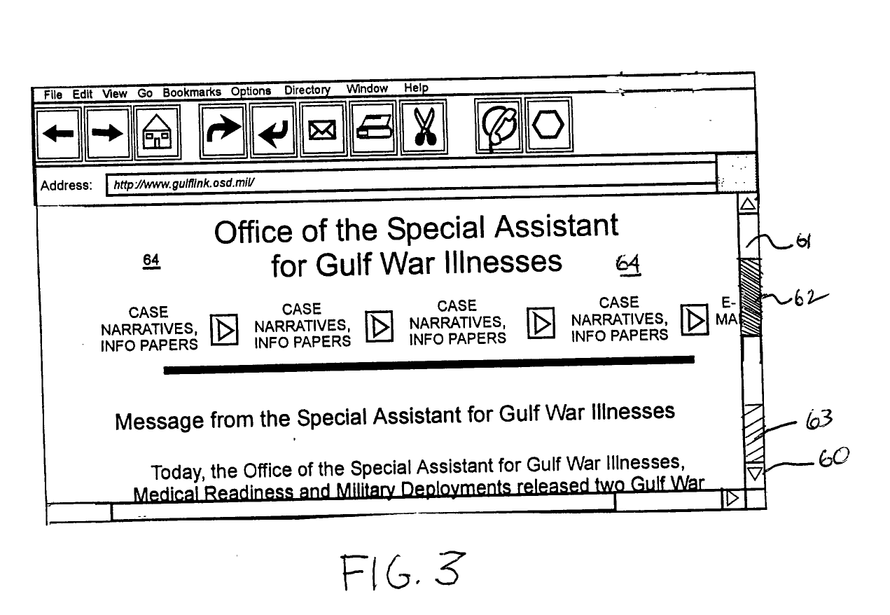

A generalized diagram of a portion of the Web, in which the display 57 controlled by computer 56 used for Web page receiving during searching or browsing is connected as shown in FIG. 2. Computer 56 display terminal 57 may be implemented by the computer system set up in FIG. 1 and connection 58 (FIG. 2) is the network connection shown in FIG. 1. For purposes of the present embodiment, computer 56 display 57 serves as a Web display station and has received displayed Web page 48, which is one of a sequence of Web pages in a Web document. Reference may be made to the above-mentioned Mastering the Internet, pp. 136-147, for typical connections between local display stations to the Web via network servers, any of which may be used to implement the system on which this invention is used. The system embodiment of FIG. 2 has a host dial-up connection. Such host dial-up connections have been in use for over 30 years through network access servers 53 that are linked 51 to the Web 50. The server 53 may be maintained by a service provider to the client's display terminal 56, 57. The host's server 53 is accessed by the receiving or requesting terminal 56, 57 through a normal dial-up telephone linkage 58 via modem 54, telephone line 55 and modem 52. The HTML file representative of the Web page 48 has been downloaded to display terminal 57 through Web access server 53 via the telephone line linkages from server 53, which may have accessed them from the Internet 50 via linkage 51. The Web browser program 47 operates within the display terminals 57 to control the communication with the Web access server 53 to thereby download and display the accessed Web pages 56 on display terminal 57. The Web documents are accessed from Web site resources 49 and 59. Web cache 46 may be used to accumulate the totals of times spent by the user in the various document portions, as will be described in greater detail with respect to FIGS. 3 through 6 as the browser program 47 controls Web document scrolling.

In FIG. 3, there is shown a Web page 64 that originated from Web sites (e.g. resource sites 49, 59 (FIG. 2)). As the user navigates through the Web document, its pages are scrolled via scroll bar 60. As the document is scrolled, the amount of time that the user or viewer spends in each portion of the scrolled document will be tracked and stored as will be hereinafter described in greater detail. Then, when the document is rescrolled or scrolled back again by the viewer, either during the same browsing session or during a subsequent browsing session (the total accumulated time spent in each portion of the document is stored along with the Web document), a color indicator will be displayed in the scroll bar 60 representative of the total time that the viewer has spent in the various portions of the document. In the example of FIG. 3, a red color for scroll bar section 62 indicates that its corresponding document portion has had a high cumulative time spent therein. Similarly, the yellow color of section 63 indicates that only a modest amount of time has been spent in the portion of the page while the white color of section 61 indicates that only a minimal amount of time has been spent in its corresponding page portion. It should be noted that the described playback of document 64 may be carried out in a mode where the time spent in each portion of the document is not tracked; the circumstances may be such that the viewer is only interested in what was considered important in the previous viewing or browsing. On the other hand, the playback may be carried out in a dynamic mode wherein the system continues to track and accumulate time spent in each portion, even during playback, and the colors in the scroll bar indicative of such time spent may be dynamically and continuously changed to reflect such changing time.

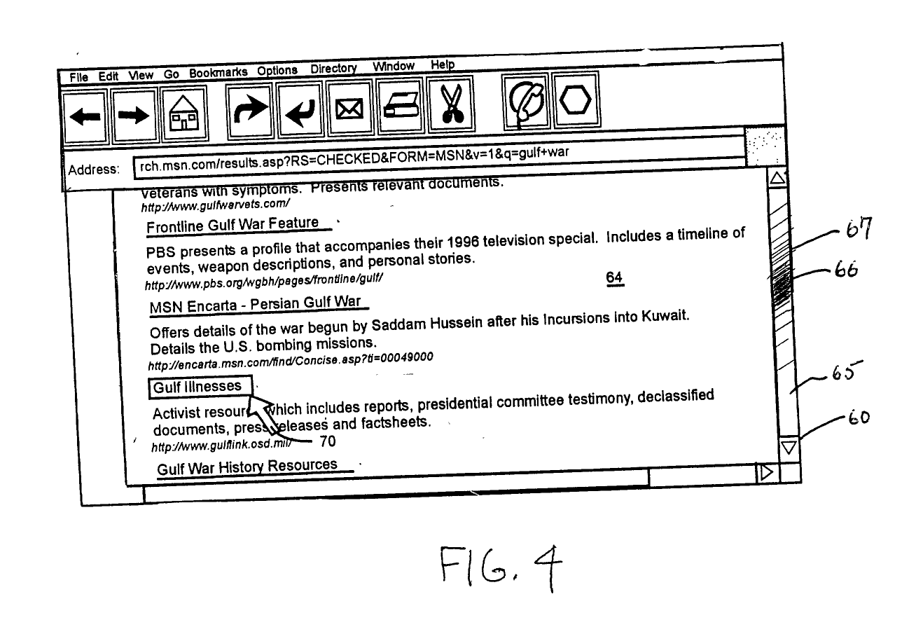

FIG. 4 illustrates some varied aspects of the invention. The discrete portions tracked and timed may be quite small, even a line or two in width. In such a case, the color indicator differentiation in scroll bar 60 may appear to be virtually continuous, e.g. varying from a color 66 indicative of intense time usage through a color 67 indicative of less time usage to color 65 indicative of little time usage.

It should be noted that for purposes of illustration, the changes have been shown compacted into a single scrolled display screen. In actuality, these color changes are likely to be reflected over dozens of display screens in the lengthy documents that this invention may be most effectively used for. In this connection, in a particular Web page representative of a Web site, such as display screen 64, FIG. 4, the user via pointer 70 may click on a hyperlink, “Gulf Illnesses”, and be connected to another Web page (not shown) that will become part of the tracked Web document.

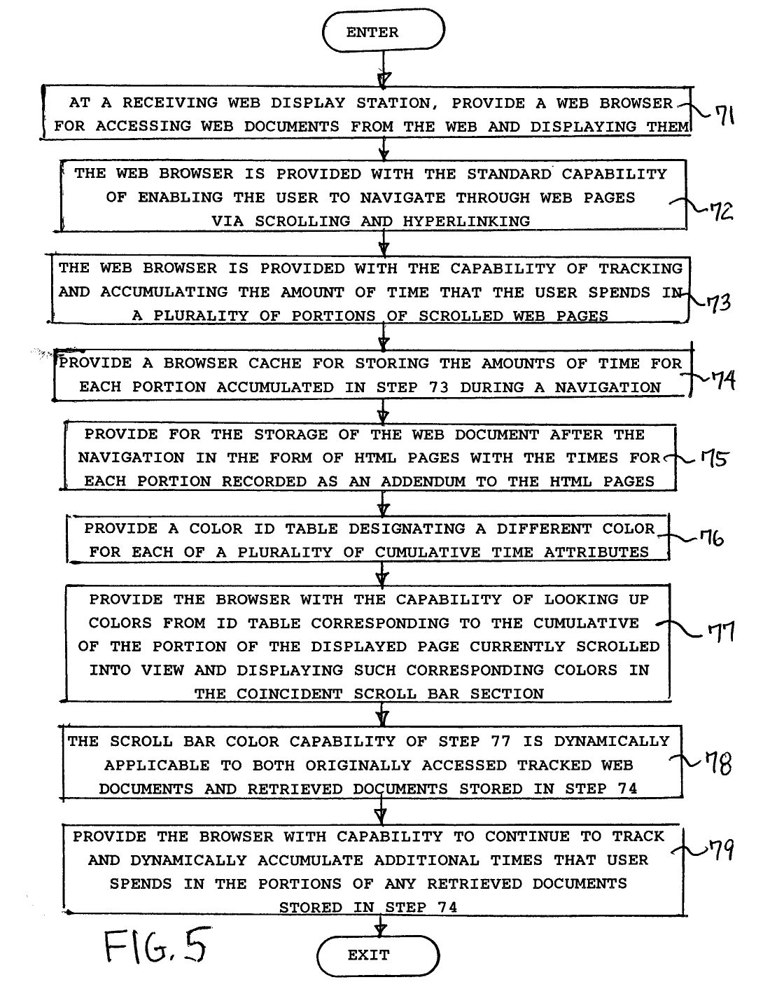

FIG. 5 is a flowchart showing the development of a process according to the present invention for tracking accumulated user time spent in document portions and providing a scroll bar indicator identifying such user times. The illustration will be at a Web receiving station where there is provided a Web browser for accessing pages from the Web and for loading and displaying such pages at a receiving display station, step 71. The browser is provided with the capability to enable users to navigate the received pages via a scroll bar and hyperlinking, step 72. The Web browser is provided with the capability of tracking and accumulating the amount of time that the user spends in a plurality of portions of the scrolled Web pages, step 73.

While a variety of techniques for such scrolling will be evident to those skilled in the art, the following example may be set up:

Set up portions, each=n scrolled lines;

Mark time when the page is scrolled into a portion;

Mark time when page is scrolled out of a portion;

Count time difference;

Add time difference total accumulated for portion.

Provision is made for storing the total accumulated time for each portion during scrolling, step 74. At the end of a browsing session, provision may be made for conventionally storing the Web document in the form of its HTML pages, step 75. However, the tracked accumulated times for the portions should be stored as an addendum to the HTML Web document. According to conventional HTML functions, this addendum may be in the form of an embedded attachment, marked off by appropriate HTML tags that the browser will read during the display of the HTML document and look up in the color look-up table referred to in subsequent steps 76 and 77. Dependent on the user's storing arrangements, the Web document may be stored on his browser cache for a period of time, or the Web document along with its addendum may be stored at the facility of his Web service provider who maintains the Network Access Server 53, FIG. 2, for the user.

There is provided, step 76, a color ID table designating a different color for each of a predetermined plurality of levels of user time spent in the particular portion of the Web document. Accordingly, step 77, a routine is provided so that when a document having such accumulated times stored therewith is displayed and scrolled and enters the next designated portion, the accumulated time is noted, the color for that time is looked up on the table, and the color is coincidentally in the scroll bar. As set forth above, the program may be set up so that step 77 may be dynamically carried out in both initially accessed Web documents, as well as retrieved Web documents with the accumulated times stored therewith, step 78. Finally, the browser is provided with the capability to continue to track and dynamically accumulate additional times that the user spends in the portions of any retrieved web documents stored in step 74.

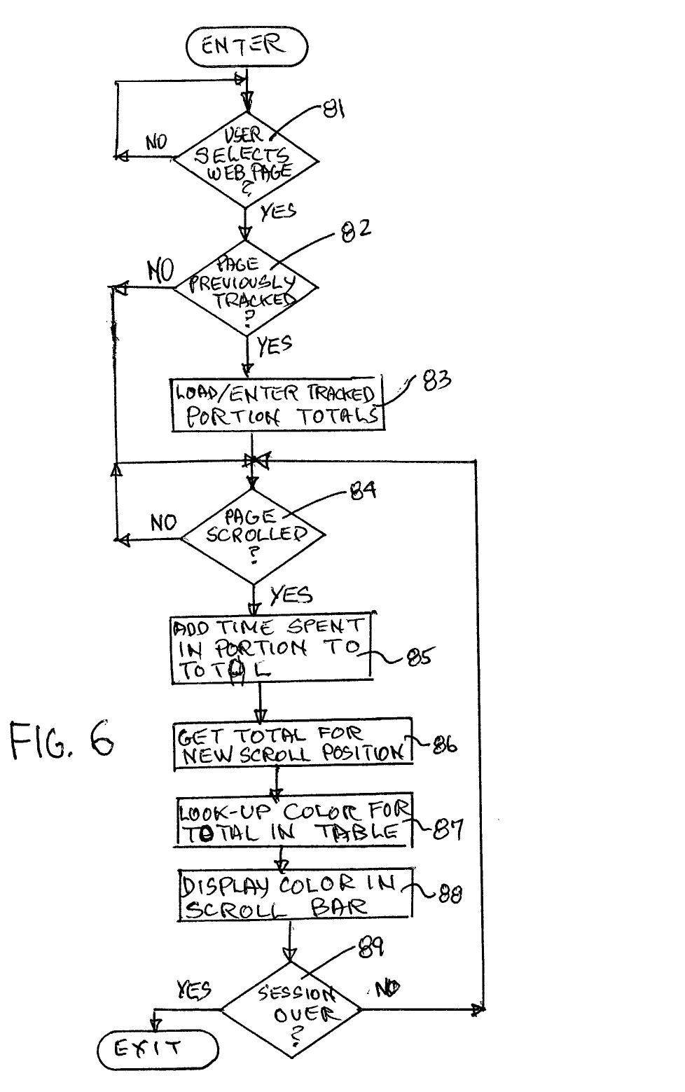

The running of the process set up in FIG. 5 will now be described with respect to the flowchart of FIG. 6. The flowchart represents some steps in a routine that will illustrate the operation of the invention as set forth in the above process. An initial determination is made, step 81, as to whether the user has requested a Web page. If No, the process is returned to step 81 and the selection of such a page is awaited. If Yes, then the browser obtains and loads the requested Web page. A determination is then made as to whether the page has been previously tracked for accumulated times, step 82, e.g. whether the HTML Web document has an associated addendum of such accumulated times. If Yes, the tracked times for each portion are loaded along with the document, step 83. If No, such times will not be loaded. In either case, a determination is made as to whether the page has been scrolled out of the instant portion, step 84. If No, the process is returned to step 84 and the accumulation of time spent continues to be tracked. If Yes, the time spent in the last portion is added to the total for the last portion, step 85. The accumulated total for the next portion is gotten, step 86, and the color for that total is looked up in the look-up table, step 87. The color is displayed in the coincident position in the scroll bar, step 88. At this point, an illustrative determination may be made as to whether the present browsing session is over, step 89. If Yes, the session is exited but the Web document and its accumulated time totals are saved as described above. If No, the session is returned to step 84 and the scrolling is continued.

One of the preferred implementations of the present invention is in application program 40, i.e. a browser program made up of programming steps or instructions resident in RAM 14, FIG. 1, of a Web receiving station during various Web operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a World Wide Web (Web) communication network with user access via a plurality of data processor controlled interactive receiving display stations for displaying received hypertext documents having a plurality of display pages containing text, images and media, a system for dynamically tracking and indicating a user's interest in the portions of a received lengthy document comprising:
means enabling a user to interactively navigate in a received Web document;
means for tracking the cumulative time that said user spends in each of a plurality of document portions during the navigation of the received Web document; and
means for visually indicating within the received Web document said tracked cumulative time spent in each of said portions.

2. The Web document tracking system of claim 1 wherein:
said Web document pages include hyperlinks to other document pages; and
further including means responsive to user selection of said hyperlinks for linking pages into said lengthy Web document;
whereby said means for tracking also track cumulative user time spent in portions of said linked pages.

3. The Web document tracking system of claim 1 further including:
means for accessing a previously tracked Web document; and
means for displaying within the accessed previously tracked Web document visual indications of said previously tracked cumulative time spent in each of said portions.

4. The Web document tracking system of claim 1 further including:
means for storing a tracked Web document including said visual indications of said tracked cumulative time spent in each of said portions; and
means for interactively displaying said stored tracked Web document.

5. The Web document tracking system of claim 4 wherein:
said stored Web document is an HTML document; and
said visual indications of said tracked cumulative time are a stored addendum to said HTML document.

6. The Web document tracking system of claim 4 further including:
means for interactively displaying a stored previously tracked Web document;
means enabling a user to interactively navigate further in said displayed previously tracked Web document;
means for dynamically tracking the additional cumulative time that the user spends in each of the plurality of document portions during the further navigation in the displayed Web document; and
means for dynamically visually indicating within the displayed Web document said tracked total cumulative time spent in each of said portions.

7. The Web document tracking system of claim 1 wherein said means for indicating said cumulative tracked time comprise color indicators.

8. The Web document tracking system of claim 7 wherein said means for indicating said cumulative tracked time comprise a vertical scroll bar for sequentially scrolling the Web document through a sequence of positions including said color indicators for indicating the cumulative tracked time for the Web document portions at said positions.

9. The Web document tracking system of claim 1 further including Web browsing means at a receiving display station comprising:
said means enabling a user to interactively navigate in a received Web document;
said means for tracking the cumulative time that said user spends in each of a plurality of document portions during the navigation of the received Web document; and
said means for visually indicating within the received Web document said tracked cumulative time spent in each of said portions.

10. The Web document tracking system of claim 9 wherein said means within said Web browsing means for indicating said cumulative tracked time comprises a vertical scroll bar for sequentially scrolling the Web document through a sequence of positions including said color indicators for indicating the cumulative tracked time for the Web document portions at said positions.

11. In a Web communication network with user access via a plurality of data processor controlled interactive receiving display stations for displaying received hypertext documents having a plurality of display pages containing text, images and media, a method for dynamically tracking and indicating a user's interest in the portions of a received lengthy document comprising:
enabling a user to interactively navigate in a received Web document;
tracking the cumulative time that said user spends in each of a plurality of document portions during the navigation of the received Web document; and
visually indicating within the received Web document said tracked cumulative time spent in each of said portions.

12. The Web document tracking method of claim 11 wherein:
said Web document pages include hyperlinks to other document pages; and
further including the step of linking pages into said lengthy Web document in response to user selection of said hyperlinks;
whereby said tracking also tracks cumulative user time spent in portions of said linked pages.

13. The Web document tracking method of claim 11 further including the steps of:
accessing a previously tracked Web document; and
displaying within the accessed previously tracked Web document visual indications of said previously tracked cumulative time spent in each of said portions.

14. The Web document tracking method of claim 11 further including the steps of:
storing a tracked Web document including said visual indications of said tracked cumulative time spent in each of said portions; and
interactively displaying said stored tracked Web document.

15. The Web document tracking method of claim 14 wherein:
said stored Web document is an HTML document; and
said visual indications of said tracked cumulative time are a stored addendum to said HTML document.

16. The Web document tracking system of claim 14 further including the steps of:
interactively displaying a stored previously tracked Web document;
enabling a user to interactively navigate further in said displayed previously tracked Web document;
dynamically tracking the additional cumulative time that the user spends in each of the plurality of document portions during the further navigation in the displayed Web document; and
dynamically visually indicating within the displayed Web document said tracked total cumulative time spent in each of said portions.

17. The Web document tracking method of claim 11 wherein said cumulative tracked time is indicated by color indicators.

18. The Web document tracking method of claim 17 wherein said cumulative tracked time is indicated within a vertical scroll bar for sequential scrolling of the Web document through a sequence of positions, and said color indicators indicate the cumulative tracked time for the Web document portions at said positions.

19. The Web document tracking method of claim 11 further including a Web browsing process at a receiving display station including said steps of:
enabling a user to interactively navigate in a received Web document;
tracking the cumulative time that said user spends in each of a plurality of document portions during the navigation of the received Web document; and
visually indicating within the received Web document said tracked cumulative time spent in each of said portions.

20. The Web document tracking method of claim 19 wherein said cumulative tracked time in said Web browser process is indicated within a vertical scroll bar for sequential scrolling of the Web document through a sequence of positions, wherein said color indicators indicate the cumulative tracked time for the Web document portions at said positions.

21. A computer program having code recorded on a computer readable medium for dynamically tracking and indicating a user's interest in the portions of a received lengthy Web document in a Web communication network with user access via a plurality of data processor controlled interactive receiving display stations for displaying received hypertext documents having a plurality of display pages containing text, images and media, said computer program comprising:
means enabling a user to interactively navigate in a received Web document;
means for tracking the cumulative time that said user spends in each of a plurality of document portions during the navigation of the received Web document; and
means for visually indicating within the received Web document said tracked cumulative time spent in each of said portions.

22. The computer program of claim 21 wherein:
said Web document pages include hyperlinks to other document pages; and
further including means responsive to user selection of said hyperlinks for linking pages into said lengthy Web document;
whereby said means for tracking also track cumulative user time spent in portions of said linked pages.

23. The computer program of claim 21 further including:
means for accessing a previously tracked Web document; and
means for displaying within the accessed previously tracked Web document visual indications of said previously tracked cumulative time spent in each of said portions.

24. The computer program of claim 21 further including:
means for storing a tracked Web document including said visual indications of said tracked cumulative time spent in each of said portions; and
means for interactively displaying said stored tracked Web document.

25. The computer program of claim 24 wherein:
said stored Web document is an HTML document; and
said visual indications of said tracked cumulative time are a stored addendum to said HTML document.

26. The computer program of claim 24 further including:
means for interactively displaying a stored previously tracked Web document;
means enabling a user to interactively navigate further in said displayed previously tracked Web document;
means for dynamically tracking the additional cumulative time that the user spends in each of the plurality of document portions during the further navigation in the displayed Web document; and
means for dynamically visually indicating within the displayed Web document said tracked total cumulative time spent in each of said portions.

27. The computer program of claim 21 wherein said means for indicating said cumulative tracked time comprise color indicators.

28. The computer program of claim 27 wherein said means for indicating said cumulative tracked time comprise a vertical scroll bar for sequentially scrolling the Web document through a sequence of positions including said color indicators for indicating the cumulative tracked time for the Web document portions at said positions.

29. The computer program of claim 21 further including a Web browsing program at the receiving display station at which said received Web document is displayed comprising:
said means enabling a user to interactively navigate in a received Web document;
said means for tracking the cumulative time that said user spends in each of a plurality of document portions during the navigation of the received Web document; and
said means for visually indicating within the received Web document said tracked cumulative time spent in each of said portions.

30. The computer program of claim 29 wherein said means within said Web browsing program for indicating said cumulative tracked time comprises a vertical scroll bar for sequentially scrolling the Web document through a sequence of positions including said color indicators for indicating the cumulative tracked time for the Web document portions at said positions.

31. In a Web communication network with user access via a plurality of data processor controlled interactive receiving display stations for displaying received hypertext documents having a plurality of display pages containing text, images and media, an implementation for dynamically tracking and indicating a user's interest in the portions of a received lengthy document comprising:
an implement enabling a user to interactively scroll the pages of a received Web document on a display screen;
a counting device for tracking the cumulative time that said user spends in each of a plurality of document portions during the scrolling of the received Web document; and
an implement for visually indicating within the received Web document said tracked cumulative time spent in each of said portions.

32. The Web document tracking implementation of claim 31 further including:
a storage device for storing a tracked Web document including said visual indication of said tracked cumulative time spent in each of said portions; and
an implement for interactively displaying said stored tracked Web document.

33. The Web document tracking implementation of claim 32 further including:
an implement enabling a user to interactively further scroll the pages of the displayed stored Web document;
a counting device for dynamically tracking the additional cumulative time that the user spends in each of the plurality of document portions during the further scrolling in the displayed Web document; and
an implement for dynamically visually indicating within the displayed Web document said tracked total cumulative time spent in each of said portions.

34. The Web document tracking implementation of claim 32 wherein said implement for indicating said cumulative tracked times comprise color indicators.

35. The Web document tracking implementation of claim 34 wherein said implement for indicating said cumulative tracked time comprises a vertical scroll bar for sequentially scrolling the Web document through a sequence of positions including said color indicators for indicating the cumulative tracked time for the Web document portions at said positions.
